(19) United States
(12) Patent Application Publication
(10) Pub. No.: US 2009/0138188 A1
(43) Pub. Date: May 28, 2009

(54) METHOD, DEVICE AND SYSTEM FOR MODELING A ROAD NETWORK GRAPH

(76) Inventors: Andrej Kores, Ljubljana (SI); Bogdan Pavlic, Zagorje ob Savi (SI); Martin Pecar, Kojsko (SI); Tajet Novak, Kamnik (SI)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/996,462

(22) PCT Filed: Jul. 22, 2005
(86) PCT No.: PCT/IB05/02129

§ 371 Date: Jul. 14, 2008

(51) Int. Cl. G01C 21/26; G06G 7/70; G06F 17/10; G06G 7/78

(52) U.S. Cl. 701/117; 703/8; 703/2

(57) ABSTRACT

There is provided a method, device and system for modeling a road network graph, comprising the steps of receiving information data from a plurality of vehicles, said information data comprising at least positional data, and modeling said road network graph in accordance with said received data.

### FIELD OF THE INVENTION

The present invention relates to the field of modeling (or generating or shaping or adapting) a road network graph showing the single topographic structure (shape, profile or contour respectively) of roads, streets and other traffic relevant connections. Further a server device and a system are provided which are adapted to effectively perform a method of modeling said graph.

### BACKGROUND OF THE INVENTION

With an increasing number of vehicles more or less steadily in the last couple of decades, today especially in the developing and fast growing countries such as China, Russia and Brazil, there is also a demand to provide the drivers with accurate route and traffic navigation and to provide road system planners with data that help them cope with ever increasing traffic.

There are some advanced systems put in place in the world today to tackle both tasks. Developed nations have produced digitized models of their road systems in the last couple of years, enabling drivers to find their way. This system is known today as vehicle navigation. These systems are sometimes supplemented by systems providing real-time traffic data which is usually acquired by road system operator and dispatched to the vehicles equipped with navigation devices using broadcasting or similar technology (RDS, etc.).

All of these systems require tedious collection and verification of data with geodetical means (using modern techniques such as GPS). Furthermore acquiring data on the traffic conditions requires installation of vehicle by-pass recognition devices (so called loops, microwave curtains, cameras and similar), reporting of unusual events by drivers themselves and monitoring by special vehicles, planes or helicopters. While the latter measures are almost unavoidable when real-time data are concerned it provides less useful data to road system planners.

### SUMMARY OF THE INVENTION

The object of the present invention is to provide a methodology, a device and a system for modeling a road network graph, which overcomes the deficiencies of the state of the art.

The objects of the present invention are solved by the subject matter defined in the accompanying independent claims.

According to a first aspect of the present invention, a method for modeling a road network graph, preferably performed on at least one modeling server is provided. Said method of modeling may encompass a method of calculating said graph, a method of (preferably automatic) profiling of said graph, a method of (preferably automatic) updating and a method of verifying said graph. Said method comprises at least the steps of: receiving information from a plurality of vehicles, said information data comprising positional data, preferably geopositional data of said plurality of vehicles; and modeling said road network graph in accordance with said received data. Thereby an effective updating of road network graph is achieved in a reliable and economic way.

Further, the method of calculating said graph may comprise an automatic calculation of the road network geometry (position data), topology (connection data) and statistics (traffic amount, average speeds etc). Thereby, detailed traffic data and statistics may be obtained, for use in navigation systems and in traffic control/planning apparatus.

Further, the method of calculating said graph may use measurements from the vehicles, included in the system (said information), or graph network information from other sources (government agencies, mapping or road construction companies, recognition of aerial photographs or other imagery, etc.). In this case it is basically graph merging. Thereby information from several sources can be merged.

Further, the method of profiling may be comprised of (preferably automatic) steps of abstract representation of roads and junctions and setting their parameters, according to said information. Thereby, the graph can be completed and transformed into other (more abstract) graph representations.

Further, said information data may also be obtained from a third party, for instance. This holds especially for the kind of information, that said plurality of vehicles (verification vehicles not included) is not equipped to measure, for instance street names or speed limits. Thereby another source is acquired.

The method for updating said graph substantially corresponds to the method for profiling it. One basic difference is reporting significant changes in the graph and a step of graph computation on the new subsections.

The verification method may be comprised of inspection of the graph, which is also done by specially equipped verification vehicles, which traverse road network and look for inconsistencies with the said road network graph and provide additional information about it. By using previously provided said road network graph an optimization step within a certain process for verification may be implemented. Said optimization may be optimizing the routes for verification vehicles. Thereby, a further means of cross-checking and verifying the road network graph is provided.

According to another embodiment of the present invention, said modeling is based on mathematical techniques for processing curves, arcs, polynomials or the like performed on said data. Thereby, said modeling may be implemented within a computer system by using said mathematical techniques. That is, different data may be processed with the same method for instance thereby achieving reproducible results, for instance.

According to another embodiment of the present invention, said modeling is based on Bezier curves techniques performed on said data. Preferably Bezier curves may be used because of good approaches reached in practical embodiments by using said curves.

According to another embodiment of the present invention, said information data may comprise of vehicle type, vehicle speed, acceleration and the like. Advantageously, said data may comprise additional information (mentioned above) which allows improved modeling of said road graph. By means of said additional parameters it is easy to study the certain behavior (driving) of a special car, for instance.

According to another embodiment of the present invention, said received information data represent a trajectory of at least one vehicle from said plurality of vehicles. Each trajectory is preferably described by Bezier curves. Said Bezier curves allow proper and exact representing of said trajectories, corresponding to the certain route of a special vehicle. According to an advantageous embodiment averaging trajectories associated with said at least one vehicle may be provided. Due to averaging, an exact representation of the trajectory may be achieved. The main trajectory is calculated on the basis of a plurality of trajectories resulting in an improved model. Said plurality may origin from one certain vehicle or even from different vehicles.

According to another embodiment of the present invention, calculating a first approximation of said road network graph on the basis of said received information data, profiling of roads and junctions within said first approximation resulting in a profiled road network graph and performing a verification of said profiled network are provided. The above mentioned steps improve the resulting representation of said road network graph. Said first approximation is used as a first approach and the following steps may be iteratively performed corresponding to a closed loop, i.e. said loop corresponds to an advantageous implementation according to the present invention.

According to another embodiment of the present invention, said calculating is based on Bezier curves techniques. Preferably, said calculation may be based on Bezier curves which deliver accurate and detailed results.

According to another embodiment of the present invention, detecting changes of an existing road network graph on the basis of said received information data; storing said changes; and implementing said changes in said existing road network graph are provided. Thereby, changes in an existing road network are detected and according to the present invention the methodology will implement the changes on the basis of an already modeled or calculated graph for instance.

According to another embodiment of the present invention, said implementing is based on statistical information. Said statistical information generally corresponds to traffic information like average speed of a travelling vehicle according to e.g. times of the week, time needed to get from a location A to B using said vehicle or using another type of vehicle etc. Other traffic condition may be used as said statistical information. It is contemplated to even use the behavior of a certain driver as statistical information data. For instance a professional driver like a cab driver will have another behavior during the daily trips than a normal driver who wants to get from point A to B.

Further it is contemplated that said statistical information is provided by means of a collecting/gathering process by means of measuring vehicles or the like.

According to another embodiment of the present invention, transmitting of information relating said network graph to at least one vehicle of said plurality of vehicles is provided. Thereby, remote navigation of a vehicle may be provided. That is, a driver of said vehicle will receive navigation data from the server so that the journey may be remotely controlled. Advantageously actual information relating to said modeled road network graph is conveyed to the driver to enable an economical driving behavior, for instance. Because the road network graph is automatically and/or periodically adapted the driver of a vehicle will always receive actual information about the road characteristics, for instance.

According to another embodiment of the present invention, the profiled road network graph includes information about times of traversal regarding when the road is taken. Advantageously, said times may further be used for navigation issues, for instance. Also road planning on the basis of said timing data may be implemented.

According to another embodiment of the present invention, said information from said plurality of vehicles can be compressed using mathematical techniques for processing curves, arcs, polynomials, etc. By means of said compression techniques the amount of data to be stored and/or processed may be reduced. According to an advantageous embodiment trajectories can be described by Bezier curves.

According to another embodiment of the present invention, performing a compression step of said information data selectively within said modeling entity and/or within said plurality of vehicles is provided. Thereby, compression may be realized on the vehicle side which means that the server entity may be released, that is the saved computational power may be used for other issues.

According to another embodiment of the present invention, storing said information data is provided. Thereby future usage of certain data of interests is ensured.

According to another embodiment of the present invention, said calculation is based on digital computing techniques for accurate computing of fixed-point values. Thereby, said calculation may be provided on entities based on fixed-point architectures.

According to another embodiment of the present invention, said information data comprises measurement data, and further a normalizing step of said measurement data according to predetermined threshold values is provided. By performing said normalization step the data will be represented according to predefined thresholds, which improves handling and/or illustrating for instance. It can also be applied in entities based on fixed-point architectures and therefore decreasing the computational error.

According to another embodiment of the present invention, said storing is provided after execution of a compression algorithm, a hashing algorithm, an encrypting algorithm or the like. Thereby, secure and compressed data storing is achieved.

Accordingly each log is sent after the on-board device determines all necessary information.

According to another embodiment of the present invention, detecting existence of a multipath phenomenon/effect is provided and in this case less weight to said received information during said calculation step may be assigned. Thereby it is ensured that data falsified due to the multipath effect will get less weight during calculation steps, for instance.

According to another embodiment of the present invention, measuring of road dimensions by means of a position information providing entity within said plurality of vehicles is provided. Thereby, characterization of the road axis, corresponding to the shape of the trajectory, is provided. Further, detailed dimensioning of said road axis is provided corresponding to width of the street (road) etc.

According to another embodiment of the present invention, said entity is a GPS transceiver within said vehicle. However, said transceiver is adapted to receive and/or send positional data of a suitable equipped vehicle.

According to another embodiment of the present invention calculating a road network geometry, topology and statistics in an automatic manner is provided. Said calculating is automatically performed by means of a periodical algorithm for instance.

According to another embodiment of the present invention, an automatic profiling of road network graph by using said information data is enabled.

According to another embodiment of the present invention, an automatic updating of road network graph by using also said information data is enabled.

Said automatic profiling and/or updating may be also based on periodical algorithms, for instance which are repeated on a time basis.

According to another aspect of the present invention, a computer program product is provided, which comprises program code sections stored on a machine-readable medium for carrying out the operations of the method according to any aforementioned embodiment of the invention, when the computer program product is run on a processor-based device, a computer, a terminal, a network device, a mobile terminal, or a mobile communication enabled terminal.

According to another aspect of the present invention, a computer program product is provided, comprising program code sections stored on a machine-readable medium for carrying out the operations of the aforementioned method according to an embodiment of the present invention, when the computer program product is run on a processor-based device, a computer, a terminal, a network device, a mobile terminal, or a mobile communication enabled terminal.

According to another aspect of the present invention, a software tool is provided. The software tool comprises program portions for carrying out the operations of the aforementioned methods when the software tool is implemented in a computer program and/or executed.

According to another aspect of the present invention, a computer data signal embodied in a carrier wave and representing instructions is provided which when executed by a processor causes the operations of the method according to an aforementioned embodiment of the invention to be carried out.

According to yet another aspect of the present invention, a server device for modeling a road network graph is provided. Said server device comprises at least a component for receiving information data from a plurality of vehicles, said information data comprising positional data and a component for modeling said road network graph in accordance with said received data.

According to yet another embodiment of the present invention, said server further comprises a component for calculating a first approximation of said road network graph; a component for profiling of roads and junctions within said first approximation resulting in a profiled road network graph; and a component for performing a verification of said profiled network. All elements within said profiled network graph are thereby updated on the basis of the data which originated from said plurality of vehicles. This means that all elements will receive additional attributes on the basis of the vehicle data. Said profiling operation may also be periodically provided to ensure steadily update of said network elements. Additionally, some attributes which may be used for the profiling operation may be collected from other existing databases like for instance government databases, road construction companies etc. The data corresponding to said attributes may be manually and/or automatically inserted for further usage within said profiling (and also modeling) step. It should be noted that all collected information may be stored and further used at any time.

According to yet another embodiment of the present invention, said server further comprises a component for detecting changes of said road network graph on the basis of said received information; a component for evaluating said changes; and a component for including said changes in said road network graph.

According to yet another embodiment of the present invention, said server further comprises a component for analyzing said road network graph on the basis of said received information; and a component for reporting analysis results to a third party.

According to yet another embodiment of the present invention, said server further comprises a component for performing a compression step of said information selectively within said modeling entity and/or within said plurality of vehicles.

According to yet another embodiment of the present invention, said server further comprises a component for storing said information.

According to yet another embodiment of the present invention, said server further comprises a component for detecting existence of a multipath phenomenon/effect; and further a component for assigning less weight to said received information.

According to yet another embodiment of the present invention, said server further comprises a component for measuring of road dimensions by means of a position information providing entity within said plurality of vehicles.

According to yet another embodiment of the present invention, said received information represents a trajectory of at least one vehicle from said plurality of vehicles, wherein each trajectory is described by Bezier curves, for instance, and said server further comprises a component for averaging trajectories associated with said at least one vehicle.

According to yet another aspect of the invention a system for modeling a road network graph is provided, said system comprising a plurality of server devices and a plurality of information data providing vehicles.

Further, according to a preferred embodiment of the present invention Bezier curves may be used for modeling said road network graph. 1.

Throughout the detailed description and the accompanying drawings same or similar components, units or devices will be referenced by same reference numerals for clarity purposes.

### SHORT DESCRIPTION OF THE DRAWINGS

The accompanying drawings are included to provide a further understanding of the invention, and are incorporated in and constitute a part of this specification. The drawings illustrate embodiments of the present invention and together with the description serve to explain the principles of the invention. In the drawings,

FIG. 1 shows a flow chart illustrating the principle of the method in accordance with the present invention;

FIG. 2A shows operational sequence in accordance with the present invention;

FIG. 2B is a flow chart showing the principle of detecting changes in accordance with the present invention;

FIG. 2C shows real-time analysis and reporting of traffic data in accordance with the present invention;

FIG. 3 shows the principle of a system in accordance with the present invention;

FIG. 4 is a on-board-unit device according to one embodiment of the present invention; and

FIG. 5 is the principle of a logging automatic in accordance with another embodiment of the invention;

FIG. 6 shows the principle of averaging several trajectories, represented by Bezier curves.

Even though the invention is described above with reference to embodiments according to the accompanying drawings, it is clear that the invention is not restricted thereto but it can be modified in several ways within the scope of the appended claims.

### DETAILED DESCRIPTION OF THE INVENTION

The following description introduces a system in accordance with the present invention, which provides a generation and verification of a digital, preferably vectorized (or described with curves) model of road network, efficient update of the digital model of road network, profiling (setting the attributes) of the digital road network. To achieve the aforementioned task the system uses stored route data received from a large number of vehicles equipped with position (GPS, GALILEO or similar) receivers transmitting their position and other data to a server.

These receivers are preferably equipped also with wireless data transmitters, which transmit the stored data on traveled route at certain times, more or less frequently, wherein according to another option the data from the receiver will be manually read and transferred later to a central storage.

The amount of data, which accurately describes the routes, is enormous. This is why a special compression is needed—either before transmitting data to central local (for lower cost of communication) or before storing it. All data may be stored on a remote server or a multitude of them and special software tools can be used to combine all available data for a desired set of data corresponding to a geographical area to be analyzed.

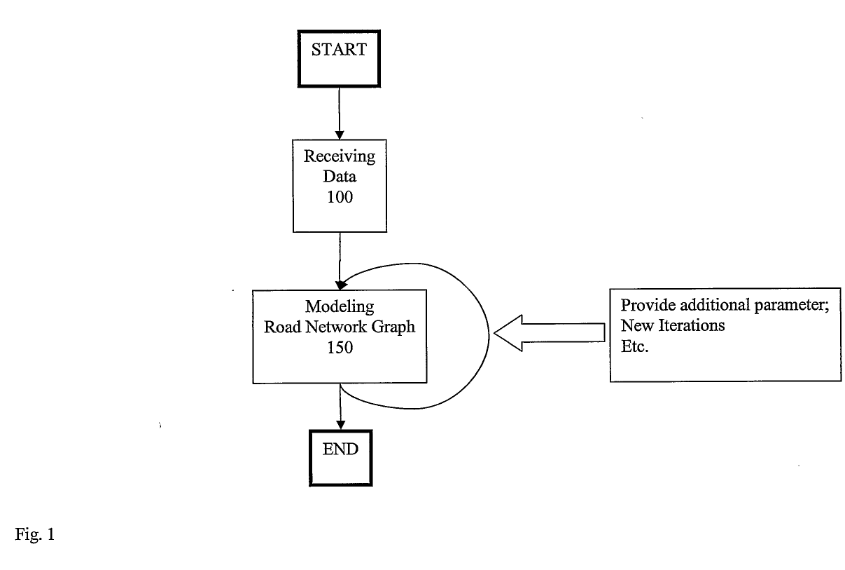

FIG. 1 schematically shows the principle of the present invention on the basis of a dataflow diagram. The operational sequence in accordance with the invention may be started by any means. Said starting operation may be provided automatically, by means of user input or the like. It is contemplated that the operational sequence will be activated or started, respectively if new data are received or determined.

In a next operational step 100 receiving of data is provided, wherein said receiving of data may be a process which is continuously or periodically repeated. This operation corresponds to data acquisition, which is hereinafter described. In a next operational step said road network graph is modeled, at 150. All modeling calculations and operations may be based on Bezier curves as described in the following. After all modeling and calculation steps have been finished the methodology may come to an END and may be restarted which corresponds to a new operation according to FIG. 1.

It is contemplated as well, that the modeling step 150 may receive additional information from other entities within the system. This means that new iterations or the like may be controlled by means of external processes or operations or even by means of user input, for instance. While receiving additional parameters corresponding to information from said plurality of vehicles the modeling step 150 may be restarted until a desired result is achieved.

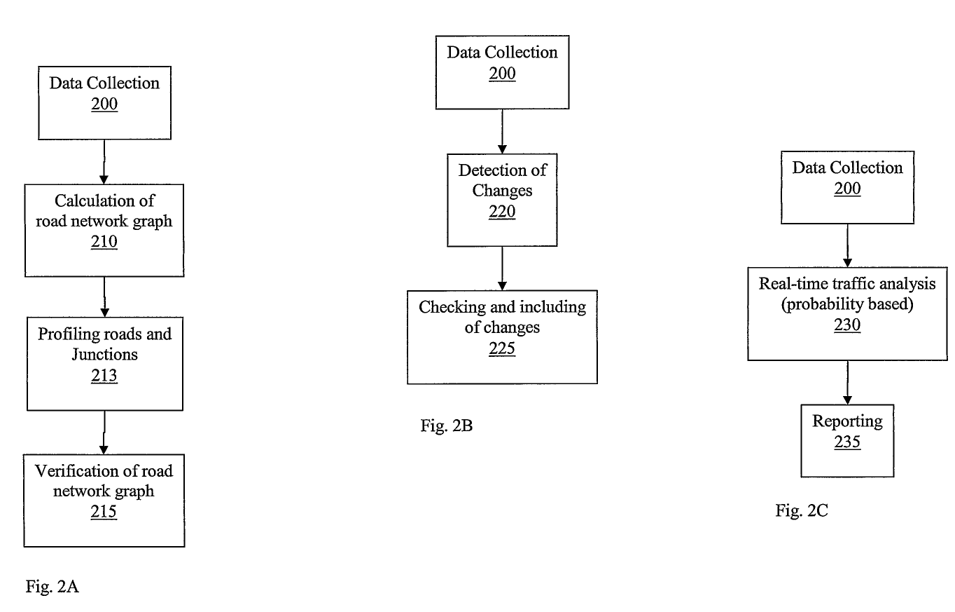

With reference to FIG. 2A to 2C, the system may work as follows. Generally, there are three basic processes. The first process, FIG. 2A, is an initial calculation, which gives the first result of a road network graph.

The second process, FIG. 2B, can be repeated periodically, e.g. once a month. This provides the system with a regular update of the changes in the road network system. Said changes may either correspond to changes on the road network size (geometry and/or topology) or on its statistics (attributes). Other changes which are to be used for update issues may be implemented within the scope of the present invention.

The third process, FIG. 2C, is constantly analyzing current traffic situation. If a special situation is detected (with high statistical probability), the system reports it to the appropriate recipient (traffic control center, police, etc.).

With reference to FIG. 2A the process representing an initial calculation of the road network graph is depicted. In a first operational step data collection 200 is provided. This means, that a plurality of suitable equipped vehicles deliver/send position information to a central server, for instance. It is contemplated that said sending is provided periodically or even manually. This means that the achieved data, currently located in a storage of said vehicle, must be somehow transmitted to said central server or provider, for instance. In a next operational step, 210, calculation of a first approximation of said road network may be provided, wherein said approximation corresponds to an initial road network graph. According to the first set of position information a first calculation of an approximation of the graph may be performed. This first approximation will correspond to a provisional representation of the road network and must be of course amended or revised. Next, profiling of roads and/or junctions, 310, is provided. During this step some parameters like road direction and/or kind of junction, and also other attributes like average speed, for instance, time (needed for traveling a certain connection or distance, respectively) or the like may be added which may be according to step 215 verified. The verification step 215 may provide a first verification of the first approximation and subsequently said graph may be steadily enhanced and/or expanded. The main difference between step 215 and 225 is the fact that step 215 is preferably performed on the whole graph while step 225 is only performed on certain detected/determined changes.

With reference to FIG. 2B the updating and actualization of said first approximation is depicted in principle. The data collection step is similar with the aforementioned step according to FIG. 2A. The suitably equipped vehicles steadily deliver among other data position information. Said data may also comprise information about vehicle type, driver etc. In a next step 220 a comparison between existing data, included in the existing graph, and the newly received data may be provided. As a result a list of changes or even new roads etc may be signalized, so that the methodology may be able to actualize said first approximation. Said actualization step is depicted with reference to the operational step 225 in FIG. 2B and said changes may comprise the changes of the graph structures like for instance omission of existing roads or adding new ones or even its attributes (for instance velocity, time, traffic rules etc.).

It should be noted that the input for step 220 (FIG. 2B) may either be the result of the operational sequence in accordance with FIG. 2A (or some other graph) or in the future the output of the sequence according to FIG. 2B and additionally FIG. 2C.

FIG. 2C shows an operational sequence according to the present invention wherein a real-time analysis of traffic conditions is provided and further reported. As already aforementioned data collection, 200, is steadily provided and the system in accordance with the present invention is able to analyze the existing traffic data. This analysis, 230, can be based on probability theories so that a probabilistic and/or predictive traffic monitoring operation may be encountered. According to the present invention the results of said analyzing, 230, may be further reported to a third party. Said third party may correspond to a central traffic monitoring institute or even a vehicle or driver, respectively. There are a lot of contemplated configurations within the scope of the present invention.

Next the object of data acquisition or collection will be discussed in detail. The device located in a vehicle (on-board device) from said plurality of vehicles may provide its position, using a GPS signal for instance (it could also be any other similar system, such as Galileo) and possibly some dead-reckoning devices (e.g. gyroscope) every second, because it is usually the smallest time interval that GPS receivers can handle. If the measurements were connected by straight lines, they would describe the shape of the road very well. The problem achieved is the quantity of these data. That is why compression is needed. If the amount of the data will be reduced there are few advantages achieved: reducing of data transfer to the central server, decreasing of database size, (post)processing time may be decreased.

It is also contemplated that the shape of the road is described very precisely, so that the error does not exceed the width of the road or generally the road geometry. Therefore, a proper and substantially lossless compression of the shape is needed.

For this issue Bezier curves of third order may be used to describe the shape of the road. Bezier curves are very flexible and geometrically simple to represent. Those curves can describe U and S shapes, cusps and loops. Other curves could be used, too like Bezier curves of higher order, arcs, polynomials, etc. Another contemplated feature is to describe other information data also, not just the shape of the trajectory. Along with it velocity, engine rotations, etc. can be described and made available

Generally, the term trajectory relates to describing the journey/trip or traveling of a vehicle in a certain environment. This means, according to a trivial description, that the trip of a certain car may be represented by a line (curve), wherein each point of said line describes the actual, geographical position (altitude may be included as well) of the vehicle. It is further contemplated, that each point on the trajectory will be associated with the actual velocity, acceleration of the vehicle or similar which is advantageous for further calculating or modeling issues.

### Setting the Time Interval Between Two Logs

The time interval between two logs depends heavily on the shape of the road. The wording log relates to storing certain information from said plurality of vehicles. The on-board device may log several positional data before sending them to the server. Said positional data corresponds to a traveling route (trajectory) of said vehicle. The data may be sent spontaneously without storing, or as already mentioned above the positional data may be accumulated (main purpose of component 415) and may further be sent.

Generally, a long portion of a highway can be well approximated by a single curve; while on the other hand, a winding mountain road has just a short portion of it, which can be described by one curve. The time interval is usually longer on main roads. The goal is to obtain a description of the road (the path or trajectory of the vehicle) with a minimal number of elements and minimal error as well.

Therefore a heuristic approximation may be needed. The on-board device has a buffer, which contains a series of consecutive measurements. The length of the buffer is equal to the length of the largest time interval between consecutive logs (if measurements have valid positions—if the on-board device is not in a tunnel or a garage without a gyroscope). Advantageously, the smallest time interval allowed may be set. This way a lower and upper bound of the quality of the compression can be achieved, according to the invention.

Further, because not all measurement data are available (said buffer is to small) a heuristic approach may be employed to determine the suitable representation of a trajectory of a certain vehicle.

The basic idea is that the measurements in the buffer are approximated by a curve (for instance a Bezier curve) in predetermined time intervals such as every second, for instance. If the already performed approximation is good enough, we can omit some of the measurements to save on the resources for computing the approximation in the future. If the approximation exceeds a predefined error threshold, the process must stop and log(store) the existing curve with the measurement at the end of it and empty the buffer. This is how we can ensure a small (below a predefined threshold) error (not regarding GPS error!) in the description of the road. There are also other conditions which trigger logging of current measurements.

According to the present invention those measurements may be logged, which have a big, preferably bigger than a reference second derivative of velocity. At those points the acceleration changes most abruptly. The shape of the road changes gradually if the acceleration is constant. It is easier to describe the shape of the road between the points of maximum second derivative of velocity.

According to the present invention a threshold for the second derivative may be set. If this threshold is exceeded at a certain measurement, then a curve to that measurement (along with it) can be logged. Thus, a minimal number of elements in the description of the road are thereby achieved according to the present invention.

The current (or the last satisfactory) curve and measurement are logged, if abnormal behavior of the GPS signal is encountered, such as multipath phenomenon or losing signal (when entering a tunnel). In this manner errors or false measurement may be avoided. Multipath phenomenon or effect respectively means that GPS signals from the satellites are reflected or they may interfere with other signals, such that the data or signal communication may be erroneous. In this case the receiver determines the current position erroneously.

The aforementioned basic idea may be applied on other quantities (e.g. velocity), and not just on the shape of the road. Measurements of this quantity are approximated every second and if the approximation is not good enough the approximating process may be stopped and further the last satisfying approximation may be registered. If scalar quantities (numbers) are observed, it is contemplated to use polynomials instead of curves, for instance.

Experimental observations are showing that said aforementioned approximation enables logging every 30-40 seconds (on average) while describing the shape of the roads accurately up to a few meters tolerance. Said observations were approximated by means of Bezier curves of 3^{rd} order according to the present invention. Otherwise the time difference can substantially vary. Generally, the higher is the curve order the longer is the time difference between logs (time between two sub successive position logs).

### Multipath Effect or Phenomenon

One of the biggest problems when trying to accurately describe the shape of the road is the multipath phenomenon. If it lasts for a short period of time, it can be detected from coincidence of: the difference in the direction, reported by the GPS receiver, and the direction, calculated from the GPS coordinates, and increased estimated error of the coordinates.

If this phenomenon is detected, then the measurements, involved in it, are assigned smaller weight than others when said measurements are approximated, according to the present invention. Therefore more accurate measurements have more influence on the shape of the curve.

It is contemplated that measurements (and curves) are logged or stored before the phenomenon occurs. That is because the measurements (and curves) before the phenomenon are not corrupted. If the phenomenon does not exceed the maximal time interval, it is preferred not log anything until the phenomenon ends. However, correct curves or approximations rely heavily on correct measurements. If a multipath effect was determined it is contemplated that the taken measurements within this period (during multipath effect) are neglected. The same applies also if just the estimated error increases.

Application of Kalman Filter within GPS Devices

Another difficulty arises because a Kalman filter in GPS receiver as known in the art does not perfectly work if the speed of the GPS receiver is low. Therefore the reported GPS location is drifting whenever the vehicle is stopped. This can be a serious problem in urban areas with a lot of traffic jams.

The solution to this problem is not to log anything if the speed of the vehicle is low (e.g. under 3 km/h). According to the present invention the measurement (with the curve) may be logged as soon as it is detected that the vehicle has stopped and right after it starts. The measurements with low speed may be discarded, and further any approximating steps are inhibited, and just consecutive logs (just before the vehicle stops and right after it starts) with a straight curve (line) are connected.

Both of the above described problems are solved if the on-board device has a dead-reckoning device (gyroscope), but it increases the price of the on-board device.

Another problem are the boundary conditions; handling the beginning and the end of operating, temporal malfunctions, etc.

According to a possible embodiment of the present invention a following implementation may be realized. Accordingly, the following quantities every second are under observation:
GPS coordinates—position (P(t)),
estimate of horizontal error (Sigma), calculated by GPS receiver,
velocity vector, calculated by GPS receiver (WGS84 Azimuth, Speed (knots)),
velocity vector, calculated from GPS coordinates ((P(t+1)−P(t−1))/2),
acceleration (from GPS heading),
acceleration (from GPS coordinates),
derivative of the acceleration (from GPS heading),
derivative of the acceleration (from GPS coordinates),
information about the data validity (see next enumeration):
   0 no heading, no coordinates,
   1 no heading, coordinates OK,
   2 heading OK, no coordinates,
   3 heading OK, coordinates OK.

The numbering above is made just by the way of example, and the present invention is not limited thereto.

It is also needed to know whether position was calculated by GPS receiver or a dead-reckoning device. Additionally, other quantities may also be observed within the scope of the present invention.

If velocity vector, calculated by GPS receiver (Vs), and velocity vector, calculated from GPS coordinates (Vk), differ a lot, and the error estimate (sigma) rises, a very probable cause may be the multipath phenomenon.

A series of these measurements is stored in a buffer. Length of this buffer (Max) is the maximal time interval for an approximated curve. A minimal time interval (min) can be set for such a curve. However, said interval provides a lower bound for compression quality and enables not to log the last measurement in the buffer. Also a measurement that was collected up to min seconds before the current measurement may be logged. If a measurement is logged, which was collected r (<min) seconds before the current one, then the buffer is not completely emptied—last r measurements may remain within the buffer. If a circular buffer is used, it is not needed to shift those r measurements to the beginning of the buffer. Thereby, the implementation according to one embodiment of the present invention may store the starting and current position in the buffer.

Sometime logging a measurement before the current one is contemplated. Sometimes several consecutive measurements are needed for discovering a certain phenomenon. For instance five consecutive measurements can be used to calculate the derivative of the acceleration in the middle (third) measurement. In the current second the derivative two seconds ago is calculated. If that derivative is big enough, the measurement (with the curve) from two seconds ago may be logged in accordance with the present invention. The buffer is then emptied, only the last 3 (=r) measurements remain in the buffer. The unit doesn't have to do any approximating for a few seconds, until there are min measurements in the buffer. The usual routine proceeds from then on. The derivative function is smoothened using orthogonal polynomials on 5 consecutive measurements.

An additional buffer can be employed, which stores last min approximated curves, if for instance the need to log a curve from few seconds ago is desired.

Generally, there are some boundary conditions. The first measurement (with valid position) has to be logged. The same holds for the last position, after the engine was turned off. The last position outside a tunnel (with valid GPS position) has to be logged. It is also contemplated to set a threshold u of how many consecutive seconds the GPS position has to be invalid to mark it as a beginning of the tunnel. The purpose is to discard very short tunnels or errors, noise in GPS receivers. After a measurement has been logged as the beginning of a tunnel, the first measurement with valid GPS position as the end of the tunnel must to be logged. If the on-board device doesn't have a dead-reckoning device, these two logs are connected by a straight curve, a line. The time interval between the two logs can be more than Max in this case only. If the on-board device has a dead-reckoning device (gyroscope), the logging procedure inside the tunnel is the same as usually.

The next section describes choosing the logging step (log) in accordance with one embodiment of the present invention. For instance, the following three quantities (values) are observed at a given time t: A(t)=size of derivative of acceleration (scalar), V(t)=difference of velocity vectors |Vs-Vk| (scalar representation), S(t)=Sigma, estimated error (scalar value).

If A(t) exceeds a predefined threshold, then the measurement is a member (subject) for logging. If a weighted sum of V(t) and S(t) exceeds another threshold (due to possible occurrence of multipath effect), then:
If (t−1)>min then the previous measurement should be logged (to not corrupt the current curve approximation), else
If t<Max, the t-th measurement should not be logged (because the multipath effect may be terminated soon, and thereby correct ending measurements and curve approximations are possible).

It is desired to find and log a measurement with a big derivative and small multipath and error estimates. There may be two boundary values: minimal time to the new log (min), maximal time to the new log (Max).

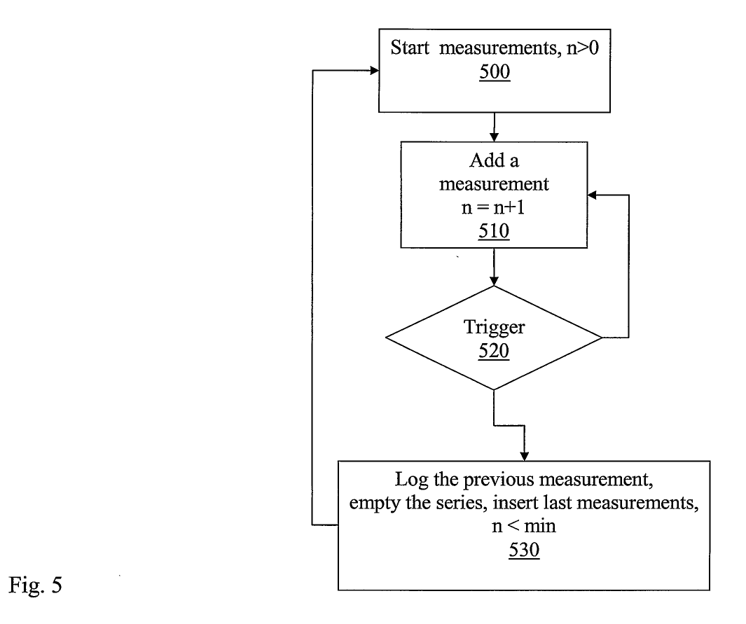

With reference to FIG. 5 an automatic in accordance with the present invention is provided. For example: (L stands for LOG, 530, m, 510 is a measurement at every second).

This is an automatic (according to FIG. 5) which has a temporary state:

Lmmmmmmmmmmmmmmmmmmm . . . =L+c*m

Said automatic performs a basic Loop:

L+c*m

If the number of current measurements c is more than min and less than Max
then
   if the trigger is set at t, t>min, t<Max, (c−t)<min, the measurement t in the series is logged and the series is emptied to L+(c−t)*m
Else

L+(c+1)*m

goto Loop

The trigger (520) may consist of several parts:
A) if the second derivative of the velocity is bigger than the prescribed threshold, this means the measurement at t1:=c−2 is a candidate for a log;
B) if the multipath phenomenon probably occurred at t2:=c−1 (difference between directions is large and estimated error has increased), then
   1. if m(t2−1) had no multipath and (t2−1)>min, then m(t−1) is a log candidate else (otherwise)
   2. if t2<Max, m(t2) should not be the logged;
C) if the calculated curve at c doesn't fit the measurements well enough, and the curve at t3:=c−1 does, then m(t3) is a candidate for a log;
D) if other scalar quantities (velocity, for instance) are observed, and the approximation of the measurements is not good enough, then m(t4) along with the curve and approximating function of this quantity should be logged, t4:=c−1. Then the minimum tm of candidates for logging (t1, t2, t3, t4) is chosen. The new log is m(tm) with the corresponding curve and possibly approximating functions of other quantities.

When trying to fit a curve to the measurements of positions, they are weighted with the weight, which decreases with increased multipath probability. If the fitting is done in fixed-point arithmetic, some special measures have to be taken.

There are also some other contemplated boundary conditions: the first valid position after starting is logged; the last valid position (when turning a car off) is logged; the last measurement before a tunnel (before GPS positions turn invalid) is logged; the first measurement after a tunnel is logged.

### Bezier Curves

A short introduction to Bezier curves of 3rd order follows, wherein advantageous adaptations in accordance with the present invention are provided.

Those curves are generally defined by 4 control points P0 to P3. The curve lies within the convex hull of the control points. The curve starts in the first control point and ends in the last. Starting direction of the curve equals the direction between first two points and ending direction equals the direction between the last two points.

Numerically, Bezier curves are defined with Bernstein polynomials over control points Pk.

$$B ( t ) = {\sum }_{k = 0}^{N} p k \frac{N !}{k ! ( N - k ) !} {{t}^{k} ( 1 - t )}^{N - k} ; 0 \leq t \leq 1$$

describes the curve, parameterized by t.

Said curves can be split by means of the De Casteljau algorithm (not shown).

Another issue is to fit the Bezier curves in accordance with the received or provided measurements. If mobile units (or devices) have a fixed-point digital signal processing unit, only fixed-point arithmetic may be used, therefore the computational error due to the fixed-point computation has to be minimized or avoided. A first improvement in accordance with the present was to include CORDIC (Coordinate digital computing) algorithms to compute norms of vectors (or curves), etc.

The second improvement in accordance with the present invention is to choose a bounding box (not tight) of measurements and normalize them according to the bounding box size and range of numbers (fixed-point arithmetic).

The state of the art teaches only to adjusts just the length of the tangent (control) vectors of the curve (between the first and the second pair of control points), but it is needed to modify the direction, as well.

The following shows how more flexibility of the shape of the fitting curve may be achieved in accordance with the invention.

The following definitions are made:

V₁=V₀+α₁t₁+β₁t₁^{P}

V₂=V₃+α₂t₂+β₂t₂^{P}

wherein Vᵢ are control points of the curve, and tᵢ are control (tangent) vectors at the ends of the curve, tⱼ^{P} is perpendicular to tⱼ. αⱼ stands for the correction of length of control vector; and βⱼ stands for the correction of direction. The solution for the βⱼ values is similar with the solution for αⱼ, which is described in the prior art.

The fitting procedure may be iterated in a loop and the loop may comprise two steps: first adjusting the length, and second adjusting the direction of the control vectors.

According to the present invention measuring of distances by means of GPS signals or information, respectively may be provided. It is possible to measure the length of a route with the help of the GPS system. If measurements are available, which are taken every second (some may be missing), it is contemplated to sum the distances between all the consecutive pairs and get a very accurate estimate of the actual length. If the velocity is low (e.g. under 3 km/h), the measurements may be discarded according to one embodiment of the present invention.

### Storage of Data

All data and information as used in the present invention and received from a plurality of vehicles may be stored at a central location (server) and may be later analyzed in a couple of stages for instance to achieve the desired result. These data entries are preferably called raw data. Raw data may include at least one of: position, speed, heading (direction), time of data acquisition, but can include also: a description of the curve (trajectory), a description of the function of other quantities (velocity etc.), horizontal accuracy estimation of position received by position receiver, number of (GPS) satellites with good signal, data from other vehicle sensors (temperature, weight) etc. Raw data may be stored so that the ride (travel or trajectory) of a vehicle is stored as a separate set of data, but however the identifier of the vehicle might be encrypted (hashed) or even not present in order to maintain privacy.

Vehicle data may comprise two attributes to further help for identifying route data: type of vehicle (passenger car, van, truck, bus, motorcycle, construction vehicle, tractor, . . . ), type of service (passenger, police, construction, taxi, municipality bus, military, farm, . . . ).

Those above mentioned two attributes may help to differentiate the public road network and the roads used by special types of vehicles (such as tractor) and the roads used by particular service with extended or limited rights (police, military, taxi, etc.).

### Road Network Computation

Raw data is first analyzed to provide vectors (curves) representing roads and organized into a directed graph (as in well known graph theory in mathematics). This process needs a small amount of very accurate measurements (as the traditional approach in geodetical praxis) or a large amount of less accurate measurements, which produce high accuracy, when averaged. According to the present invention the focus is set on the second situation.

The graph edges are the streets and the graph vertices appear when several roads are connected. Geometrically nearest vertices represent the junctions. All the operations from here on are therefore derived from standard graph theory. The resulting graph is the basic road network graph. Simply put, the analysis turns raw data from many vehicles which have traveled the same way into one vector (curve) representing the road traveled. This process is not at all trivial. It is contemplated to note that the data might not truly represent the traffic rules since some drivers might violate them.

The first goal is to produce a 2D map. It is also possible to include information about the height above the sea level, if the measurements are accurate enough. It is necessary to compute two properties of the road network properly: geometry, meaning accurate positions of road axes, topology, meaning correct connections between the roads.

Geometry is basically computed by averaging the trajectories of vehicles, which were on the same road. Topology is basically computed by checking which trajectories connect which roads. There are several strategies for roadmap calculation. Two basic approximations are described: a local and a global version. The distance between sampled points of roads at both of them may be defined.

The local version is more locally (in terms of distance) focused. It progresses locally by prescribed distance between sampled points. It focuses on the density of resulting graph. This calculation of the map is based on two steps: calculation of road sections and calculation of road junctions.

The basic operation is calculating a single curve between two sampled points, corresponding to an averaging of the measurements. According to experimental tests a distance of 100 m between two sampling points was chosen. According to the present invention it is preferred to describe sections of a road between two sampling points as a straight line if the distance between the points is around 20 m. Thereby, the produced error is not significant and the road section is suitable represented.

According to the present invention, Bezier curves may be used for representing vehicle trajectories and their computed averages in the graph, because of their numerical stability and geometrical flexibility and clarity.

### Averaging of Bezier Curves

This procedure is part of the present invention and is used for calculating the geometry of the roads, but it could be used for other purposes, too. According to the present initial observation a plurality of trajectories provided by a plurality of measuring vehicles is provided. Each trajectory of each vehicle is described by consecutive Bezier curves, in accordance with the present invention. These curves usually have different lengths. To obtain the exact geometry of the road axis or road subsection, respectively, an averaging step of all present trajectories may be provided, according to the present invention. The averaged curves have to be short enough to describe all the road network details accurately enough. Accordingly, averaged Bezier curves, which were less than 100 m long, were employed.

The next section will describe the averaging step of a set of trajectories described by Bezier curves in accordance with the present invention. An object is to average several trajectories. Firstly, a starting and an ending point for each averaging may be chosen. Starting and ending point from which to which the trajectories are averaged can also be set as a line, that is perpendicular to the trajectories, according to the present invention.

It is assumed that average trajectory between the starting and ending point (line) can be sufficiently well described by a Bezier curve according to the invention.

Before averaging the given curves at points, closest to chosen starting and ending point (or lines) may be split. Thus, a result according to subsections of trajectories is obtained, which are very similar.

There may be several ways for performing said averaging, according to the invention:
1. If all the subsections between starting and ending point are described by single curves, it is preferred to simply average the control points of the subsections. Otherwise, another way of averaging may be chosen, which is described next.
2. Averaging:
   Starting and ending coordinates in these subsection
   The velocities (lengths of control vectors) in these starting and ending coordinates
   Lengths of subsections
   Time differences of each subsection between the starting and ending coordinates Thus, enough data to guess the trajectory is provided (see next section).
3. Fitting a new Bezier curve to measured positions (coordinates—points on the original curves) in this subsection (see section about data compression). If there are not enough measured positions, it is preferred to arbitrary add points on curves. It should be mentioned not to use positions which could have a big error. Using positions, which are very close to starting or ending point on each subsection, may be unfavourable, because the error of these positions has more influence on the shape of the curve—thereby, sometimes small loops may appear.

### Guessing or Determining the Trajectory

In case the trajectories are not described with Bezier curves, but measurements are close enough, the trajectory can be guessed and described with guessing a Bezier curve as follows.

Without compression, the data from the vehicles consists of positions, directions (headings) and velocities in these positions and time and distance between consecutive positions. For the roadmap calculations, it is necessary to have information about what the trajectory between these positions was. If the recorded distance matches with length of said guessed curve, it may be considered as satisfactory.

According to the following values: a starting and ending point of the trajectory, the vector of velocity at the beginning and the end, the distance, time, which is needed to travel this path, a step of guessing the trajectory in between said points may be provided.

According to the present invention the trajectory may be guessed or calculated by means of a Bezier curve of 3rd order. The starting and ending point are fixed and they are the first and the last control point, as known in Bezier curves techniques. Next the position of the middle of two control points is to be determined. The second control point is obtained from the first with the velocity vector added, and the third control point is obtained from the last with the velocity vector subtracted. Then, normalized velocity vectors are multiplied with an appropriate factor (e.g. speed [m/s]*time[s]/3) for the first approximation of these points. Then the length of the curve may be computed and it may be adjusted if necessary (see next section).

### Adjusting the Length of Bezier Curve

This is useful when an approximation of the curve with correct directions is given. Length is a contemplated additional factor, if only two degrees of freedom are left—length of starting and ending vector. This procedure changes both vectors uniformly, because velocities usually don't change very abruptly. If the curve is shorter than the actual data, it is preferred to prolong the velocity (control) vectors; and if it is longer, it is preferred to shorten the vectors, and repeat the process. When the actual and the required length are close enough then the operational sequence may stop. Nevertheless said adjusting is provided in an iterative manner so the desired result may be obtained after a certain number of operations.

### Calculation of Road Sections

This is the step where sections of roads between the road junctions may be calculated. This step focuses on the geometry of the road network. According to the invention a starting point is randomly chosen and the operational sequence continues with the above described basic operation along the measurements until the measurements separate. This is a signal for a junction. It is also envisaged to continue the section backwards in order to acquire the full section between the junctions.

### Calculation of Road Junction

Calculation of road junctions is a separate step, because the geometry and the topology of the road network is the most complicated in the junctions. The emphasis in this step is on the topology. Measurements (logs or parts of curves) are attributed to corresponding road sections. All the measurements that lead from one road section to another are collected. They are like a flow from one pipe to another. The already described basic operation is applied on the collected measurements. It is preferred to only connect the two existing sections with the newly calculated ‘flow’ section. The same is done for all the combinations of two road sections, which are connected by the measurements.

The same procedure can be repeated on the resulting graph or performed on several graphs from different sources (government institutions, road constructing companies, etc.) instead of only on the measurements from our system.

### Global Calculation

The global version is more oriented towards geometric accuracy. It requires long paths (at least 500 m) within the measurements. It also allows a partial graph complementation.

### Calculation of a Road Section

First the starting and ending point of the road section is chosen. Then all the measurements going from the starting to the ending point and having approximately the same length are collected. The basic operation, described above, is applied on the collected data. A small portion (100-500 m) of the section at the endpoints may be discarded to avoid less accurate results.

### Appending the Road Section to the Existing Graph

When a road section is already calculated, it may be appended to the existing graph. Only the subsections may be appended, which are not included in the existing graph.

### Calculating the Graph

Further, it is needed to repeat the first two steps, until all of the measurements are used. Firstly a start with an empty graph is provided and the final result is the graph of the part of the road network, which was sufficiently covered with measurements.

### Experimental Results

Experimental observations show a high accuracy of the method in accordance with the present invention. Of course the accuracy depends on the number of measurements taken.

There are a few percents of errors in topology of the calculated graph. The errors appear mostly if there are parallel roads, closer than twice the error of GPS (typically 30 meters) apart, and in complex junctions. They are due to inaccuracy of the GPS system and too long, fixed time interval between recorded logs. The expectation is that the percentage of errors may decrease when the methodology will use compressed measurements (the dynamic time interval between logs with the fitted curve) and include the gyroscope in the on-board unit. Also the speeds and waiting times are quite accurate.

### Profiling the Network

Further a main operational step in accordance with the present invention may be identification and profiling of the junctions. Several vertices in the basic road network graph, which are connected and are close together, can be merged into a more complex structure of a junction. Basic road network graph is used together with raw data to analyze the junctions in order to define the following (and possibly others, too) properties of a junction: the traffic rules (which roads are coming into the junction, which go out, and which are connected; are there any traffic lights; which roads have priority, etc), the traffic pattern (which roads are major in a junction, what is the expected time to cross the junction), type of the junction (X or star type, roundabout, exits (such as from highway), etc.), how many lanes go to a specific direction, etc. The data in second line can be used to differentiate major roads from minor in order not to distract the driver when navigating in an area with too many minor roads.

The data is once again stored as a graph with additional auxiliary data structures (matrices, etc.).

This data would basically suffice to navigate a driver.

Furthermore profiling of the roads is provided, see also FIG. 2A to 2C. Having many vehicles traveling the same roads, there is a lot of statistic data available, such as average speed, average speed in a time of a day, etc. These data are used to profile the connection (road), which is to assign the following attributes to every connection: direction of the streets/roads (one-way, two-way), the distance, average speed or average time to travel the connection (depending on the hour of the week, or similar), validity of statistic data (to verify there is enough data available to tell something substantial about the traffic on a particular connection/road), average quantity of the traffic (relative, regarding other roads), type of the road (highway, street, local road, number of lanes, etc.), the time when it was (most recently) used, and possibly some others, too.

This is done using the road network graph and raw data. The process was described above in greater detail with reference to FIGS. 2A to 2C and in the description.

A contemplated advantage is that (thanks to the curves and fitted velocity) it is possible to provide the velocity at every point on the trajectory (travel) of the vehicle. Therefore it is possible to tell what the vehicle velocities were exactly when traversing a cross-section of the road. Other quantities (values) may be fitted analog to the aforementioned example regarding the velocity according to the present invention.

Generally, said profiling operation may be performed by using already stored traffic data anytime and on any graph (manually generated or even from other sources).

If it is observed when the roads were used, it is possible to find the roads, which were not used by (equipped) vehicles for a long time. It is very probable that such roads are no longer used and can be (usually after some checking) erased from the roadmap database. This is a very efficient way to detect auxiliary roads (used to build a highway or at other construction sites) or other roads which have ceased functioning (see section about updating the network).

The result is a digital road network system which is geometrically and topologically correct. It contains statistic data which enable very accurate fastest-path navigation due to past experience of all vehicles enrolled into the scheme. However, this data must be checked manually (with specially equipped verification vehicles) to avoid possibly proposing prohibited turns to the drivers.

### Verification

Digital road network system from the previous section should be traversed by verification vehicles, equipped with special equipment, to verify that the database (road graph) corresponds to the actual road system. Since the road system is already digitalized, it is possible to advise the driver exactly which way to go in order to achieve the least possible route traveled. Optimization can be done using one of the well known principles of route optimization (such as Chinese postman algorithm known from graph theory).

Of course, some correcting can be done manually, before the specially equipped vehicles head for checking. This can decrease necessary costs even further. Another saving is achieved if these vehicles are only sent to these roads and junctions, which were calculated out of too few or not enough accurate data. This is especially useful when changes to road network graph are detected.

This represents huge advancement over other systems where there is no road system (or at least not topologically >>ordered<< in any way) before the verification. Whenever there is an inconsistence between the actual and the digital road network system the driver must enter that data into the special equipment which then proposes new route. The changes might be permanent or temporary (with lesser effect on the digital road network system). This process makes verification by far faster and cost efficient.

Verification actually adds or removes some streets (edges in the graph) and changes the connections, the topology of it. The roads that might have never been traveled by the vehicles are not necessarily added manually. If necessary, the road is traveled a couple of times by verification vehicles in order to get it into the system.

A very contemplated aspect is that said vehicles have to check the height and width of tunnels or other obstacles, because such data is very difficult to acquire otherwise. The result is a digital road network system that can be used for navigation.

These vehicles can be equipped with vibration sensors to determine the quality of the road or other sensors, which might not be directly linked to road network, but gather other useful information, like mobile network coverage, or similar.

### Updating of the Road Network Graph

Since the on-board devices are sending data continuously, the described process can be repeated several times corresponding to an updating step. The aim is to be able to detect new sections or changes to the road network very quickly and verify the very same sections through the described process very quickly. Since newly processed raw data most probably turn out the same streets and since some of them have been proven wrong by verification process it is contemplated to pay attention to those and tag them accordingly to help the updating process avoid sending the verification staff unnecessarily.

Generally, said updating operation may be performed by using said traffic data anytime and on any graph (manually generated or even from other sources).

Raw data, sent by the on-board devices, are used for several purposes. Raw data about the trajectory of the vehicle is described with curves. For every section of the trajectory, corresponding road sections and junctions are found in the database. If they could not be found in the database, this section of the trajectory is marked and saved for road network update.

At the above-mentioned step the curve similarity is a contemplated issue. It is provided to find similar subsections of the curves in order to be able to identify, when a certain vehicle was on a certain road or road part, respectively. The sections which are out of the graph are saved and accordingly marked. When a calculation for update was started the geometry, topology and profiling can be done according to said sections according to the present invention. This is an improvement of the state of the art methodologies that only detect the changes without any further processing steps.

Thus, said approach for curve similarity may be used for other purposes, like electronic toll systems, for instance because it enables the exact determination where the vehicle is exactly located, or shape recognition in general.

The main server compares the received data with stored traffic information about road sections. If that information differs substantially, this is a reason for an alert. Typically, this would suggest a traffic jam. If several vehicles send similar information about the abnormal traffic on a specific road section, the alert is even more convincing. This operation is performed within a couple of minutes. The data is also used for post-processing. The first step is to update the traffic statistics information regarding road sections and junctions. Road sections, corresponding to new data, are found in the database and their information is updated.

Road sections also have information about the times of traversal. A regular check (e.g. once a month) finds roads, which are not used any more, and can be omitted from the database (after some checking). On the other hand, the sections of trajectories, which had no corresponding roads in the database, are used for calculation of new road sections, which are then added to the database.

### Bezier Curve Similarity

To compare two curves, for instance, they have to be aligned first. This alignment may include translations, rotations and scaling. Similarity between curves is computed out of distances (Euclidean or others) between corresponding pairs of control points, in accordance with the present invention. This computation can be summation, averaging, minimum, maximum, etc. It depends on the nature of the problem.

It is true that similar compositions of control points yield similar curves. The opposite is not always true—similar curves can be constructed with very different compositions of control points. The problem is in parameterization. This can be illustrated by an example of a straight curve, a line. The middle two control points of the line can be placed anywhere on the line and the curve will have the same shape, only the parameterization will differ.

If only the shape of the curve is contemplated, not the parameterization, one can reparameterize the curves before computing the similarity. Reparameterization can be done by sampling points on the curves and then fitting them with another curve (see section about fitting Bezier curve to an ordered set of points). This curve should have basically the same shape as the original one.

### Finding Similar Subsections at a Pair of Curves

This procedure is contemplated for roadmap computation and traffic statistics update. A long curve can describe the trajectory of a vehicle. Roads are also described as curves. It is contemplated to determine when the vehicle was on one or another road, which part of its trajectory corresponds to which road.

A definition of similarity of curves is needed first. For comparing the curves one can use
Absolute criterion. In this case the minimal length of the subsections of the curves that are compared should be set. Short pieces of curves can always be similar, because their control points are close together. One can also set some criteria about the angle between the curves (between vectors, connecting the starting and ending point, for example).
Relative criterion.

The curves can be aligned at the beginning. First a sub curve of the second curve is selected, with the endpoints closest to the endpoints of the first curve. Then the following procedure, according to the present invention, is recursively repeated:

If the curves are similar, they are recorded as similar parts. Otherwise the first curve is split (on the middle) and the second curve is split closest to splitting point of first curve. Both pairs of sub curves are compared.

At the end the pairs of similar sub curves are reported.

The described system according to an embodiment of the present invention is a very effective way to generate and profile digital model of road network. This kind of data is very contemplated in an era of mass transit. Instead of building a special infrastructure to cope with the traffic analysis the proposed system uses relatively inexpensive equipment for the vehicles which serves for other useful purposes (navigation, messaging, fleet control in general), a public wireless data network (GSM/UMTS, CDMA) and a special computer system to analyze huge volume of data. That kind of principle is foremost useful for developing countries which have quickly evolving road system and which lack enough organization skill to operate complex operations to make a digital model or road network otherwise. There are a lot of possibilities of how this system could also be used.

The on-board devices are capable of navigating the driver if they have a user interface, typically a keyboard and a screen. A request for navigation can be sent to the server, which also has current information, the server sends the results back to OBU, which presents the results and guides the driver.

The most valuable data is continuously updated digital road network model data, along with the traffic statistics, which helps navigation companies to update their routing products much faster. This is true both for countries having already mapped roads (EU, US) and especially for countries having poor digital models of road networks (Russia, China, India).

The profiled road network model helps road infrastructure planners to increase throughput where it would have most effect. The model includes traffic flow data not just in general but also for a particular time in day, day in week and so on.

A common question would probably be: how much time is needed to get from point A to point B? Every trip, trajectory can be described as an ordered set of measurements, curve. They can be marked with a trajectory identifier. Then all measurements (curves) that are close to point A and all those which are close to point B are collected. If a measurement (curve) in the first set has the same trajectory identifier as a measurement (curve) in the second set, then the trajectory between those two measurements (curves) is extracted. All such extracted trajectory subsections represent the traffic flow from point A to point B. They can be further analyzed.

Since routing data is based on statistical data (which is updated on a daily basis) it is perfect platform for optimization applications such as: multi-load, multi-delivery optimization, just-in-time delivery, optimization of arrival variation, optimization of public transport network.

In the case that the road network graph comprises timing details defining the time needed to travel the connections (road sections) of the graph it is contemplated to calculate the fastest route on a time detail basis. Said time details may characterize the traffic in dependence on the day of the week or generally the day time, for instance. For instance if a user will input the starting time the methodology in accordance with the present invention will determine the fastest route and will provide the user with the resulting journey time or the like. It is also contemplated that the user may input the desired arriving time, so that the algorithm will determine and provide the starting time etc. This could be achieved in the following way; every connection of the graph should have appended information about how long does it take to traverse it according to timing details. When searching for the fastest route, the visited elements have to include timing details, too.

Such a system could easily be modified to work as an electronic tolling system. The main advantage is that, using all the knowledge, it would not require a complete map of road network. Trajectories are measured as curves and the probability of identifying the right road with the use of a curve is far bigger than just using a single GPS coordinate measurement.

If the shape of the curves is compared, a determining of the actual location of the vehicle is much easier and more accurate.

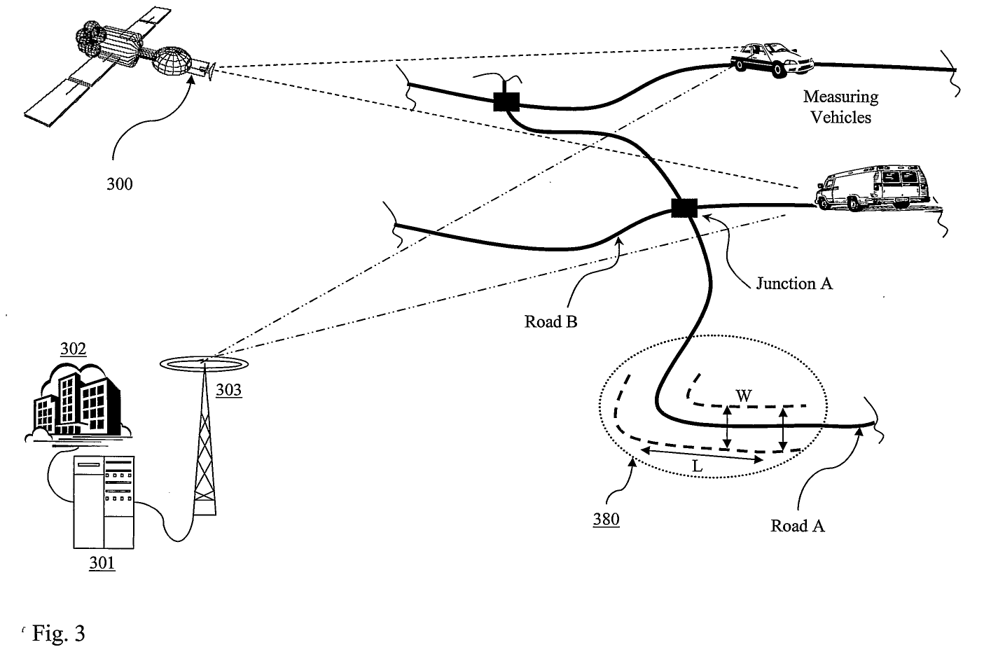

FIG. 3 shows the principle of a system according to an embodiment of the present invention. The plurality of vehicles is representatively depicted by two cars, which are equipped with suitable on-board devices. Said devices are adapted to receive GPS signals for instance and determine the geographical information of each vehicle respectively. According to this embodiment, but not limited thereto a GPS satellite 300 may be used. Said satellite 300 provides each on-board device of said measuring vehicles with a position signal. The on-board device may store all positional data or alternative it may periodically send the data to a central server 301 at a certain location 302. The server 301 is suitable equipped with a antenna 303 and of course with means for receiving signals from the plurality of measuring vehicles. All received information may be stored on the server unit or for instance on other suitable storage means. The methodology in accordance with the present invention may be run on said server 301 which serves according to this embodiment as a working (calculating) station as well. Additionally a database server may also be implemented to support said server 301 for storing the large amount of received positional data.

The trajectories of both vehicles, in this case, are named as Road A and Road B, wherein said roads show two junctions (Junction A). By means of said received information the server may store all trajectories from each vehicle respectively. Further, according to the present invention all trajectories from one or more vehicles traveling (driving) a similar road may be averaged to get accurate road models.

The area 380 shows by the way of example a part of a road assigned with some dimensions like length L and width W. According to the present invention all road sections part of the road network graph may be characterized by their parameters like: width, length, direction, altitude etc. Other parameters may be inserted additionally like: average speed, category of the road or similar. The average speed may be defined according to the hour of the day or day, for instance. Additionally said parameters may comprise statistical information like traffic statistics. Said statistics may be provided from third parties for instance and may comprise traffic jam information or even traffic statistics, like number of cars or estimated values etc.

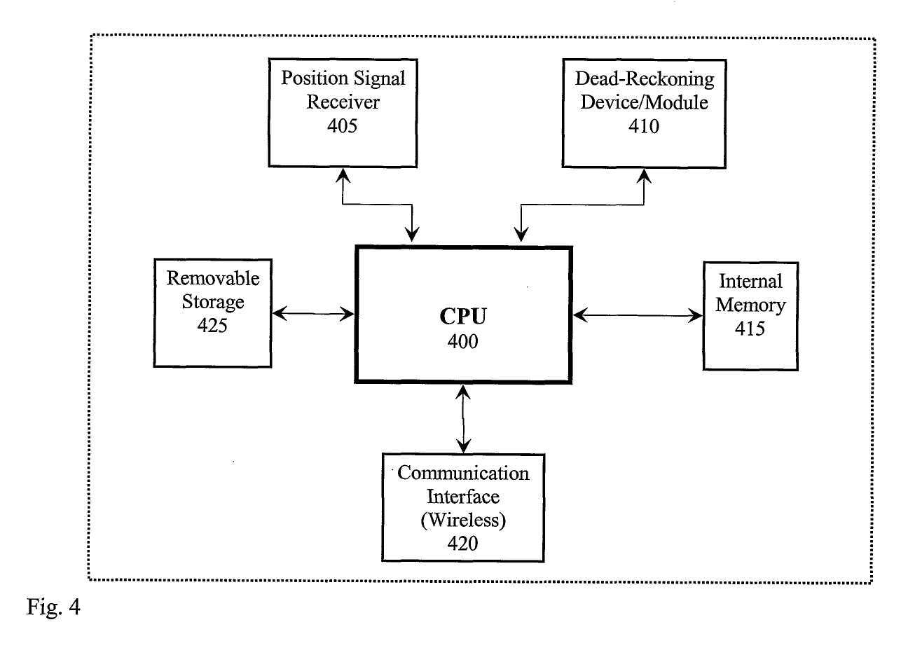

FIG. 4 shows an embodiment of an on-board device which may be installed in a measuring vehicle. Said on board device comprises a CPU 400 that is adapted to control all operations of said device. The CPU 400 may interconnect all further modules or components, respectively within said on-board device, according to FIG. 4. Said on-board device comprises: a removable storage 425, a position signal receiver 405, further a dead-reckoning module 410, a communication interface 420 and an internal memory module 415.

Said communication module 420 may be adapted to communicate with the central server by means of a certain data channel. It is contemplated to use different techniques like GSM, CDMA, UMTS, TETRA, General Radio Interface or the like.

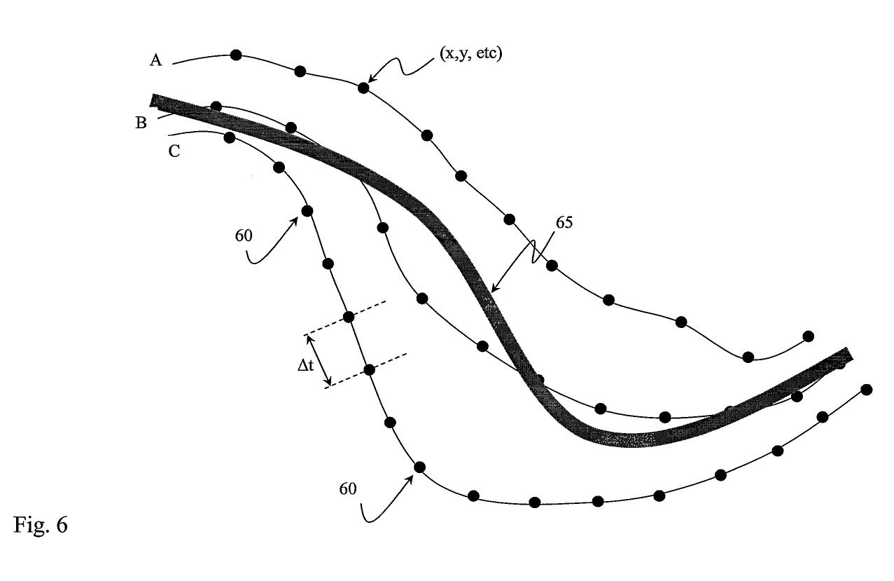

FIG. 6 shows the principle of averaging several trajectories, represented by Bezier curves, to an averaged curve. Each trajectory A, B and C is described by a Bezier curve approach on the basis of positional data information 60.

In the illustration according to FIG. 6 only the principle of the calculation according to the invention is depicted. Actually the trajectories of each vehicle are nearly identical with the real shape of the road or street under observation but for the sake of clarity a considerable difference between trajectories is shown.

Generally, each trajectory of each vehicle may be described by consecutive Bezier curves. These curves usually have different lengths. For obtaining the geometry of the road axis, it is needed to provide an averaging step on said trajectories corresponding to said plurality of measuring vehicles.

This means that the shape of the curves depends on the received positional data from said plurality of vehicles. In this embodiment only three trajectories are depicted but it is possible to perform the methodology in accordance with the present invention on a plurality of vehicles.

The positional data 60 may include geographical position data (coordinates) of said measuring vehicles, wherein said coordinates are used to describe the Bezier curves. The mathematical calculations of said Bezier curves are described above in detail in the subsection “Bezier Curves”.

In this embodiment the positional data is provided on a time basis, this means each Δt positional data will be somehow transmitted form said plurality of vehicles. The timing may vary and is not fixed according to the present invention. Thus, it is contemplated to choose a large value for said time if the route has no curves and in areas where the road has a lot of curves or junctions the time may be accordingly adapted. That is the value is decreased resulting in fine measurements of the trajectory shape.

Thereafter the trajectories A, B and C may be used to calculate an averaged curve 65 which corresponds to the existing, physical road shape. According to the invention it is contemplated to average a large amount of trajectories (Bezier curves) to get the desired result. The algorithm in accordance with the present invention allows an effective averaging of Bezier curves and from the standpoint of the computational power it is advantageous and economical.

Hence, the present invention attains automatic calculation of road network graph, wherein input is usually formed by measurements from many vehicles (included in the present system), but the same methods can be performed on some other measurements or also on existing graphs of road network.

Further, the invention attains automatic profiling of the network, wherein the input is a graph and the raw data. The graph is obtained as outmined in the specification above (calculated as above, bought from someone, etc), and the raw data are usually measurement from the vehicles in the present invention system, but it could be also from somewhere else (e.g. road names, speed limits from government agencies). In another aspect the procedure is basically about pasting (and recording) the raw data (some of its parameters) onto the graph. The shape of the curve is a contemplated aspect for identification of corresponding road and trajectory sections.

Further, automatic updating is basically corresponding to the above, wherein recognizing the sections of trajectories that do not correspond to any road sections (and vice versa—road sections that were not traversed by any vehicles lately) is of particular importance. When collecting a sufficient amount of them, one can calculate new parts of the road network graph. One aspect is that one can do that on any graph, which means one can do the updating (profiling also) on existing road graphs e.g. for EU, USA, Japan, etc.

Finally, a verification method is provided, wherein a final approval of data is encompassed. The advantage is that the present invention has an approximation (calculated graph) and can optimize the routes for the verification vehicles, which means a substantial saving.

Further a method for finding a fastest route within a road network graph is provided. Said finding is based on timing details which are part of the elements of said road network graph. However, a user of a suitable equipped vehicle may use the information provided by the network graph according to the present invention to determine (find) the temporally fastest route. For instance if a user wants to reach a certain address at a given time the methodology in accordance with the present invention will determine and calculate the fastest route. Said determination is based on the information included within said road network graph, which was profiled also by using timing details.

Furthermore, a method for inspecting the traffic flow, recorded by said information data, is provided which may be applicable for road infrastructure planning for instance. That is, the continuously adapted road network graph delivers information about traffic condition and may be used for determining crowded road subsections and/or junctions and the like.

Even though the invention is described above with reference to embodiments according to the accompanying drawings, it is clear that the invention is not restricted thereto but it can be modified in several ways within the scope of the appended claims.

1. Method for modeling a road network graph, comprising the steps of:
receiving information data from a plurality of vehicles, said information data comprising at least positional data of said vehicles, and
modeling the road network graph in accordance with the received data.

2. Method according to claim 1, the information data further comprising at least one of vehicle type, vehicle speed, or acceleration of the plurality of vehicles.

3. Method according to claim 1, further comprising the step of:
calculating a road network geometry, topology and traffic statistics in an automatic manner.

4. Method according to claim 1, wherein an automatic merging of road network graphs is carried out.

5. Method according to claim 1, wherein an automatic profiling of road network graph by using the information data is carried out.

6. Method according to claim 1, wherein a verification is carried by inspecting the graph by vehicles which inspect the road network graph at the site.

7. Method according to claim 1, wherein the road network graph is used for an optimization step during verifying the road network graph.

8. Method according to claim 1, wherein the modeling is based on mathematical techniques for processing curves, arcs, polynomials or the like performed on the data.

9. Method according to claim 1, wherein the modeling is based on Bezier curve techniques.

10. Method according to claim 1, wherein the mathematical techniques are based on averaging of curves.

11. Method according to claim 8, further comprising extending curve lengths to a desired predefined length.

12. Method according to claim 11, further comprising fitting the curve to an ordered set of points, said curve corresponding to the trajectory of a certain vehicle.

13. Method according to claim 12, further comprising computing the similarity of a certain pair of the curves.

14. Method according to claim 13, further comprising performing a similarity detection step for finding similar subsections of a certain pair of the curves.

15. Method according to claim 1, wherein transmitting of information relating the network graph to at least one vehicle of said plurality of vehicles is provided.

16. Method according to claim 1, wherein compression of the information data regarding the plurality of vehicles is carried out.

17. Method according to claim 16, wherein the compression comprises Bezier curve fitting.

18. Method according to claim 1, wherein the received information data represent a trajectory of at least one vehicle from the plurality of
vehicles, wherein each trajectory may be described by Bezier curves, the method further comprising:
averaging trajectories associated with the at least one vehicle.

19. Method according to claim 1, further comprising the steps of:
calculating a first approximation of the road network graph on the basis of the received information data;
profiling of roads and junctions within the first approximation resulting in a profiled road network graph; and—performing a verification of the profiled network.

20. Method according to claim 19, wherein the calculating is based on at least one of Bezier curves techniques or on mathematical techniques for processing curves, arcs, polynomials or the like, performed on the data.

21. Method according to claim 19, further comprising the steps of:
detecting changes of an existing road network graph on the basis of the received information data;
storing the changes; and—implementing the changes in the existing road network graph.

22. Method according to claim 21, wherein the implementing is based on statistical information.

23. Method according to claim 21, further comprising transmitting of information relating the network graph to at least one vehicle of the plurality of vehicles.

24. Method according to claim 16, further comprising:—performing the compression step of the information data selectively within the modeling entity or within said plurality of vehicles or within both the modeling entity and the plurality of vehicles.

25. Method according to claim 1, further comprising the step of:—storing the information data.

26. Method according to claim 3, wherein said calculation is based on digital computing techniques for computing of fixed-point values.

27. Method according to claim 1, wherein the information data comprises measurement data, and further comprising normalizing the measurement data according to predetermined threshold values.

28. Method according to claim 25, wherein the storing is provided after execution of a compression algorithm, a hashing algorithm, an encrypting algorithm or the like.

29. Method according to claim 3, further comprising detecting existence of a multipath phenomenon/effect and in this case assigning less weight to the received information during said calculation step.

30. Method according to claim 1, further comprising measuring at least one of road dimensions or proportions by means of a position information providing entity within the plurality of vehicles.

31. Method according to claim 30, wherein the position information providing entity is a GPS transceiver within each vehicle.

32. Method according to claim 31, wherein the GPS transceiver is coupled with a gyroscope or the like.

33. Method according to claim 1, wherein curve similarity is employed for determining of the position of a the vehicle on the road network graph.

34. A computer program product, comprising program code sections for carrying out the operations of anyone of the preceding claims, when said program is run on a processor-based device, a terminal device, a network device, a portable terminal, a consumer electronic device, or a mobile communication enabled terminal.

35. A computer program product, comprising program code sections stored on a machine-readable medium for carrying out the operations of anyone of the preceding claims, when said program product is run on a processor-based device, a terminal device, a network device, a portable terminal, a consumer electronic device, or a mobile communication enabled terminal.

36. A software tool, comprising program portions for carrying out the operations of any one of the preceding claims, when said program is implemented in a computer program for being executed on a processor-based device, a terminal device, a network device, a portable terminal, a consumer electronic device, or a mobile communication enabled terminal.

37. A computer data signal embodied in a carrier wave and representing instructions, which when executed by a processor cause the operations of claim 1 to be carried out.

38. Server device for modeling a road network graph, comprising:
a component for receiving information data from a plurality of vehicles, said information data comprising at least positional data of said vehicles; and
a component for modeling said road network graph in accordance with said received data.

39. Server according to claim 38, further comprising:—a component for calculating a first approximation of said road network graph;
a component for profiling of roads and junctions within said first approximation
resulting in a profiled road network graph; and a component for performing a verification of said profiled network.

40. Server according to claim 38, further comprising:—a component for detecting changes of said road network graph on the basis of said received information;
a component for storing said changes; and a component for including said changes in said road network graph.

41. Server according to claim 38, further comprising:
a component for analyzing said road network graph on the basis of said received information; and a component for reporting analysis results to a third party.

42. Server according to claim 38, further comprising: a component for performing a compression step of said information selectively within said modeling entity.

43. Server according to claim 38, further comprising:—a component for storing at least said information raw data received from said plurality of vehicles, attributes associated with said raw data, road network graph and the like.

44. Server according to claim 38, further comprising:—a component for detecting existence of a multipath phenomenon/effect; and further a component for assigning less weight to said received information.

45. Server according to claim 38, further comprising a component for measuring of road dimensions by means of a position information providing entity within said plurality of vehicles.

46. Server according to claim 38, wherein said received information represents a trajectory of at least one vehicle from said plurality of vehicles, wherein each trajectory is described by said mathematical techniques, said server further comprising:
a component for averaging trajectories associated with said at least one vehicle.

47. Server according to claim 46, wherein said mathematical techniques correspond to at least one of the Bezier curves, arcs, polynomials or the like.

48. System for modeling a road network graph, comprising a plurality of server devices according to claim 38 and a plurality of information data providing vehicles.
